(19) United States
(12) Patent Application Publication
(10) Pub. No.: US 2015/0229795 A1
(43) Pub. Date: Aug. 13, 2015

(54) Scanner having address management function

(71) Applicant: Aetas Technology (ZhenJiang) Co., Ltd., Zhenjiang (CN)

(72) Inventor: Bobo WANG, San Fracisco, CA (US)

(21) Appl. No.: 14/667,277

(22) Filed: Mar. 24, 2015

Related U.S. Application Data
(63) Continuation-in-part of application No. PCT/CN2013/084086, filed on Sep. 24, 2013.

(30) Foreign Application Priority Data
Sep. 24, 2012 (CN) 201210358180/1
Oct. 11, 2012 (CN) 201210385108/8
Oct. 23, 2012 (CN) 201210408611/0
Nov. 1, 2012 (CN) 201210430380/3
Nov. 19, 2012 (CN) 201210468426/0

(51) Int. Cl. H04N 1/00; H04N 1/32

(52) U.S. Cl. CPC H04N 1/00474; H04N 1/00244; H04N 1/00411; H04N 1/00419; H04N 1/00384; H04N 1/00225; H04N 1/00228; H04N 1/32496; H04N 1/32358

(57) ABSTRACT

Embodiments of the present invention provide a scanner having an address management function. Once a network address in entered into the scanner, the scanner can interact with the corresponding network device, which makes the scanner an independent device in the network. A scanner according to an embodiment of the present invention comprises: a scanning module unit; a storing unit configured to store addresses of recipients; an address management unit configured to edit and sort the addresses stored in the storing unit; an operation interface unit configured to receive selection of one or more addresses; a network connection unit connected to a network; and a processor configured to control operations performed by the scanner.

### CROSS-REFERENCE TO RELATED APPLICATIONS

This application is a continuation of international application No. PCT/CN2013/084086 filed on Sep. 24, 2013, titled “Scanner Having Address Management Function”, which claims the benefit and priority of Chinese patent applications No. 201210358180.1 filed on Sep. 24, 2012, titled “Scanner Having Address Management Function and Address Management Method”, No. 201210385108.8 filed on Oct. 11, 2012, titled “Scanner”, No. 201210408611.0 filed on Oc. 23, 2012, titled “Scanner Having Address Management Function and Address Management Method”, No. 201210430380.3 filed on Nov. 1, 2012, entitled “Scanner, Smart Scanner System and Method of Controlling Remote Printing of Scanner”, No. 201210468426.0 filed on Nov. 19, 2012, entitled “Method of Inputting Network Address in Scanner”. All of these applications are incorporated herein in their entirety by reference.

### TECHNICAL FIELD

Embodiments of the present invention relate to a scanner, more particularly, to a scanner having an address management function.

### BACKGROUND

As a device for capturing images, a scanner is capable of converting images to digital formats which can be displayed, edited, stored and outputted by computers, such as Joint Photographic Experts Group (JPEG), Tagged Image File Format (TIFF), Multi-page TIFF (MTIFF) or Portable Document Format (PDF). A scanner has a wide range of usage, for example it can scan art graphics and photos and then combine them into a file, scan printed texts and input them into a word processing software to avoid re-typing, scan faxed documents and input them into a database software or a word processing software for storing, or insert images in a multimedia file, and so on. With the popularity of Internet, network scanners have been widely used as a kind of separate devices shared in a network.

An early scanner comprises a scanning head, control circuits and mechanical components, and adopts progressive scanning to obtain digital signals which are saved for storing in the form of dot arrays. The digital signals are then edited using a file editing software into texts with standard format for storing. The current scanners are still a kind of peripheral devices of computers. As a device for capturing and inputting images, the current scanners must cooperate with computers which can display, edit, store and output the images. Photos, text pages, drawings, art paintings, photographic negatives, films, and even three-dimensional (3D) objects such as textiles, signage panels, Printed Circuit Boards (PCBs) can be the objects to be scanned and captured, and the obtained original lines, graphics, texts, photos and planer objects can be converted by computers into formats which can be edited.

The development of scanners has gone through four stages. Around 1984, the first generation of scanners were launched. They are flat-type scanners and can only scan black and white texts or line drawings. Although having many shortcomings, such as slow scanning and outputting speed, low resolution, large size and inconvenience to use, the scanners had large values and wide market prospects. Around 1986, the second generation of scanners which can scan black and white images with greyscale were launched, resulting scanned images layering and real. In 1989, the third generation of scanners which can scan color images were launched. The color scanners can scan color prints and color photos and output color image formats to computers for editing and processing. With the development and popularization of other office devices, in 1996 the fourth generation of scanners which have some functions of printers and faxes appeared. Although the scanners can be used to perform some copying, faxing and printing operations, they are still peripheral devices of computers, and all of the operations cannot be performed without computers.

It could be seen although scanners have been developed rapidly, the current scanners still rely on computers to perform their operations, which is no convenient for users, especially users of network scanners.

### SUMMARY

Aspects of the present invention are directed to a scanner having an address management function. With this scanner, users can quickly enter a network address to connect the scanner and the network device corresponding to the network address.

Aspects of the present invention are also directed to a scanner having an address management function. With this scanner, once a network address is entered into the scanner, the scanner can interact with the corresponding network device, which makes the scanner an independent device on the network.

A scanner according to an embodiment of the present invention comprises: a scanning module unit configured to perform scanning operations; a storing unit configured to store addresses of recipients; an address management unit configured to edit and sort the addresses stored in the storing unit; an operation interface unit configured to receive selection of one or more addresses of recipients based on results of the editing and sorting of the address management unit; a network connection unit connected to a network; and a processor connected to the scanning module unit, the address management unit, the operation interface unit and the network connection unit, and configured to control operations performed by the scanning module and transmission of scanned files to the one or more addresses of recipients by the network connection unit.

Aspects of the present invention are also directed to a scanner having an address management function. With this scanner, address information is stored in advance, thus users may select the sending address quickly, accurately and conveniently, without the need of entering a complex digital address each time, which reduces the times to enter or operate.

Aspects of the present invention are also directed to a scanner having an address management function. With this scanner, the addresses stored in the scanner may be sorted according to a certain rule, so that users can select a desired address quickly.

Aspects of the present invention are also directed to a scanner having an address management function. With this scanner, the scanner can download an address book from outside through the network, upload its own address book to an external storage space for backing up and sharing.

### BRIEF DESCRIPTION OF DRAWNGS

These and/or other aspects will become apparent and more readily appreciated from the following description of the embodiments, taken in conjunction with the accompanying drawings in which:

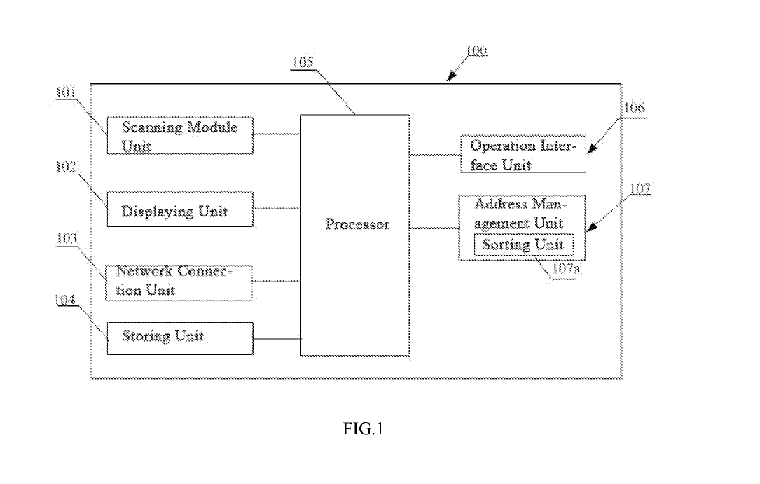

FIG. 1 is a schematic structural view of a scanner according to an embodiment of the present invention;

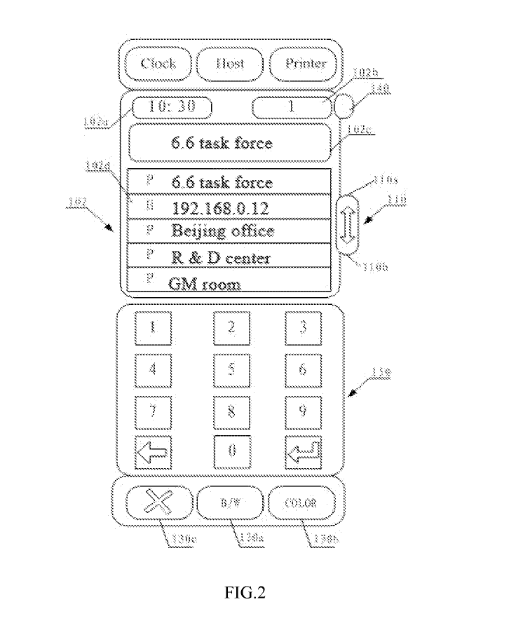

FIG. 2 is a schematic diagram illustrating an operation interface and a displaying interface of the scanner;

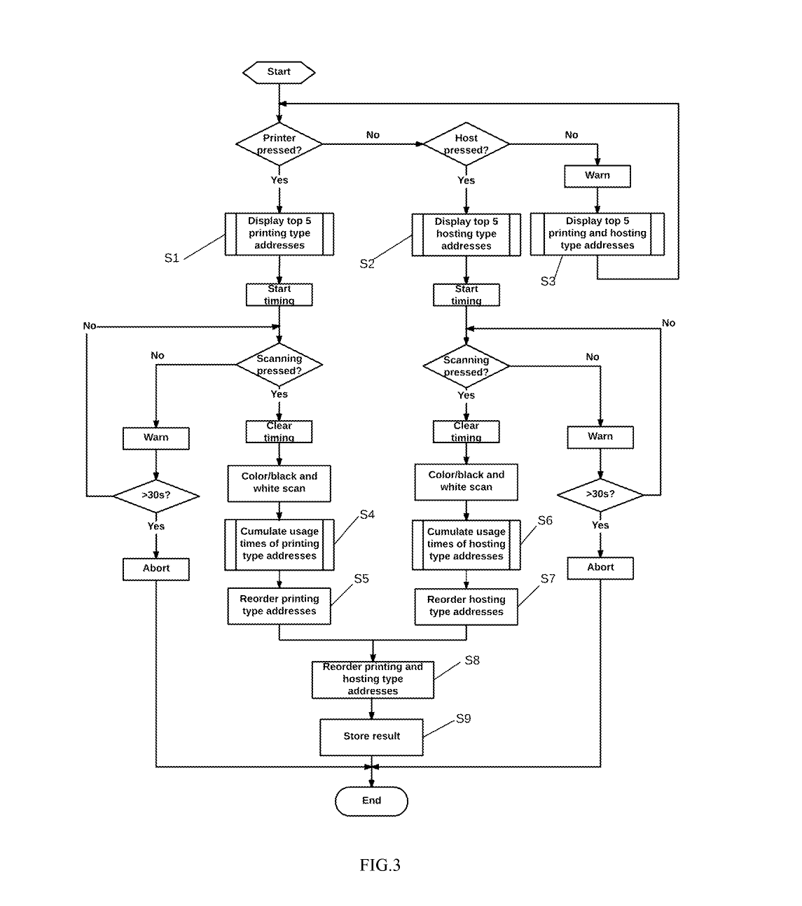

FIG. 3 is a flowchart illustrating operation of the scanner;

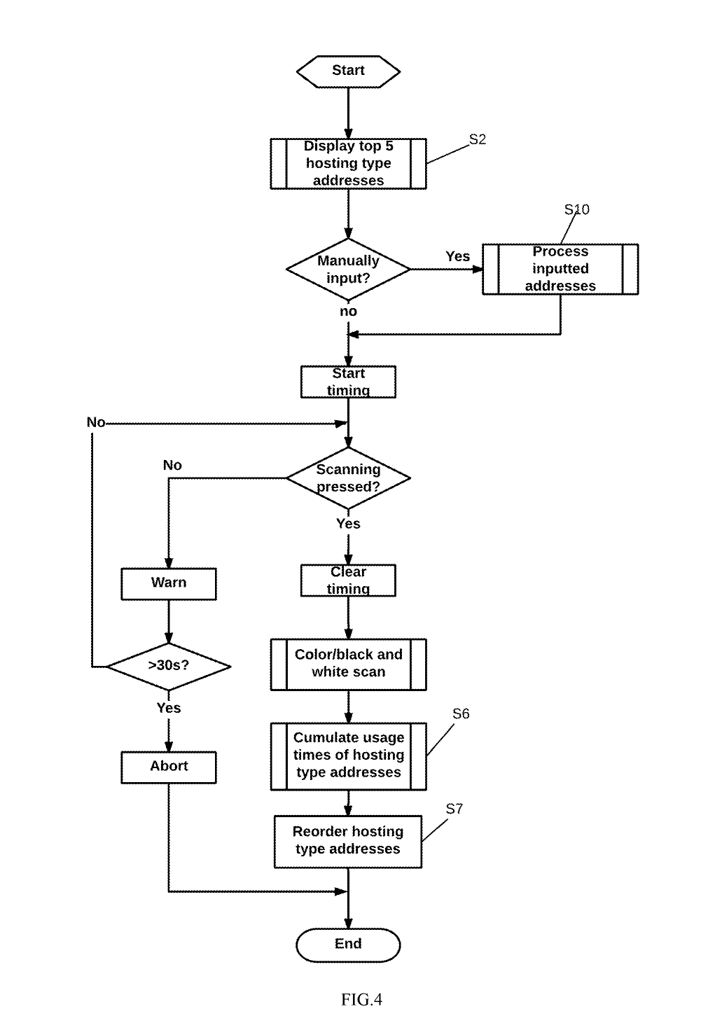

FIG. 4 is a flowchart illustrating a hosting type function of the scanner;

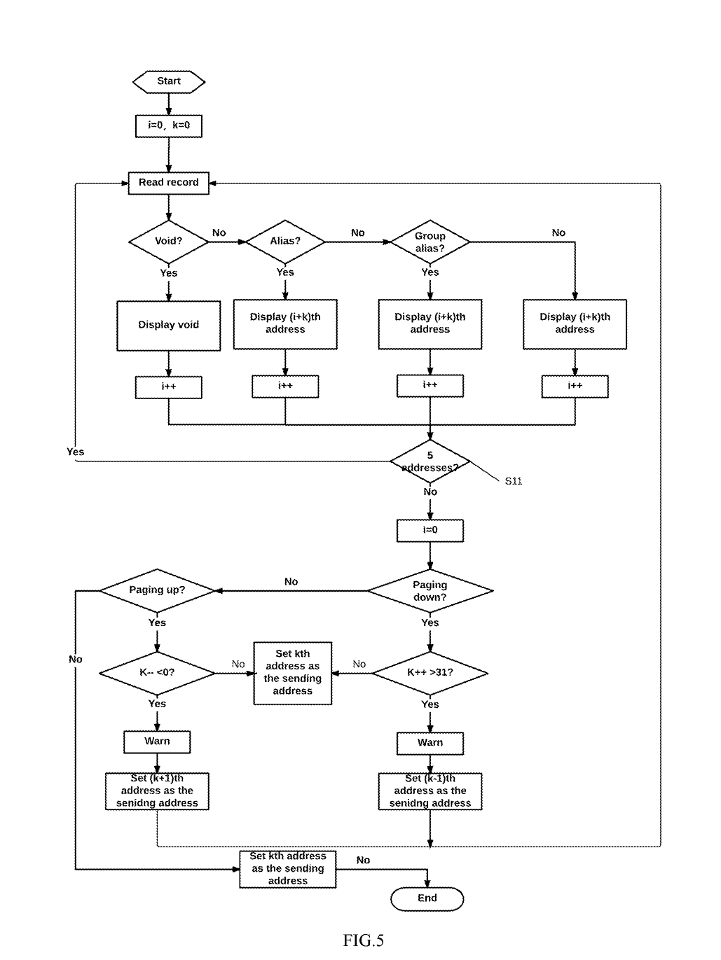

FIG. 5 is a flowchart illustrating a method of displaying top 5 hosting type addresses;

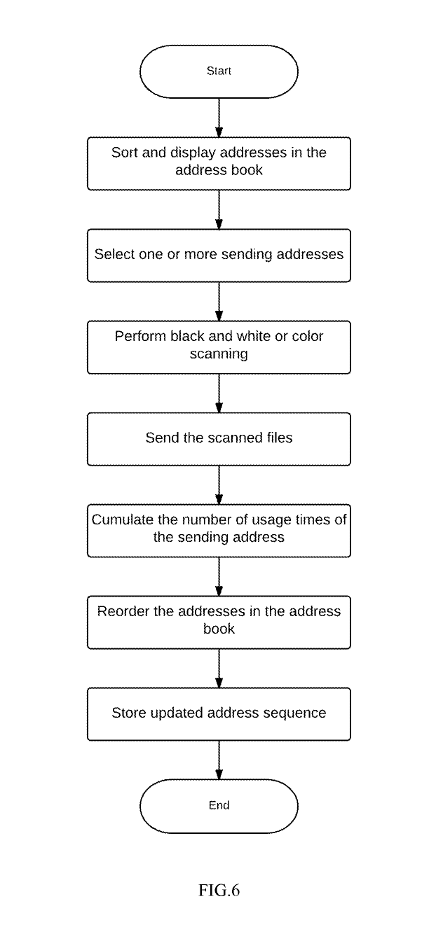

FIG. 6 is a flowchart illustrating a method of cumulating usage times of the hosting type addresses;

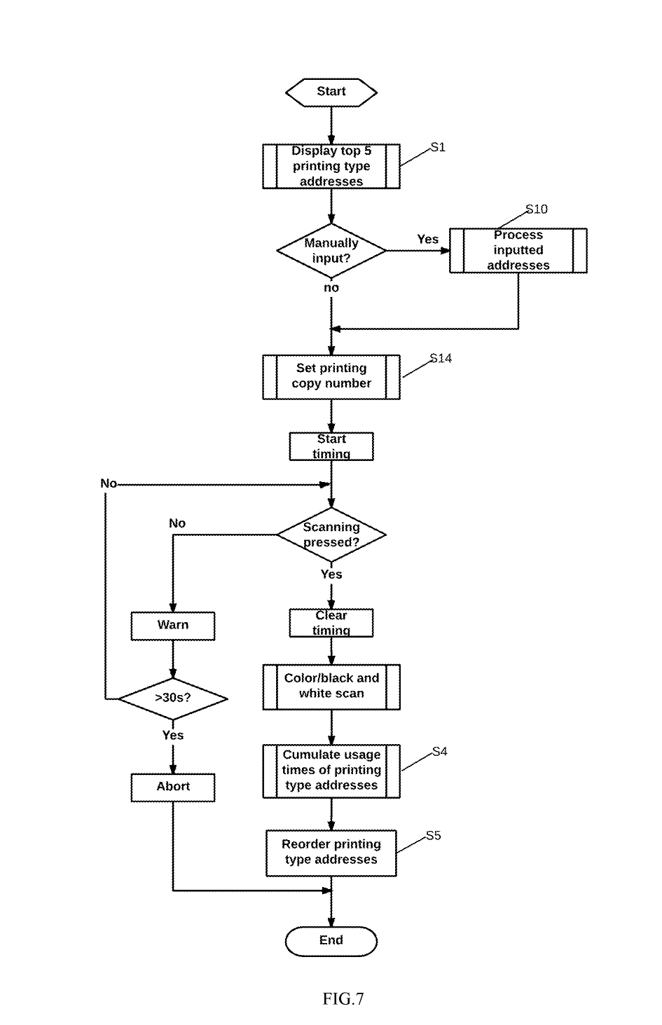

FIG. 7 is a flowchart illustrating a printing type function of the scanner;

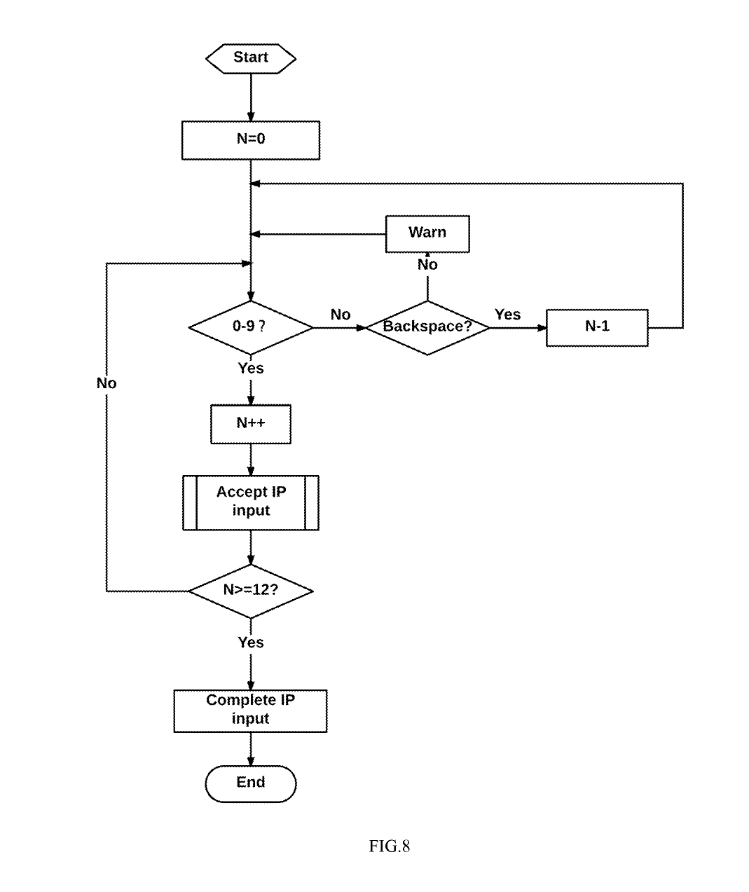

FIG. 8 is a flowchart illustrating a method of inputting addresses;

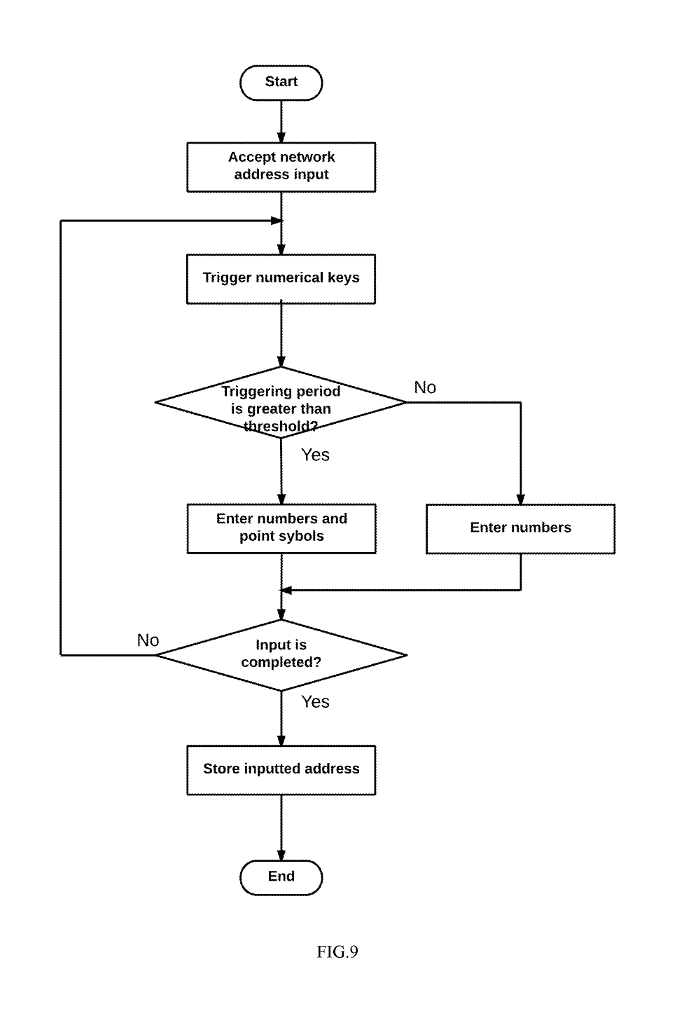

FIG. 9 is a flowchart illustrating a method of inputting network addresses;

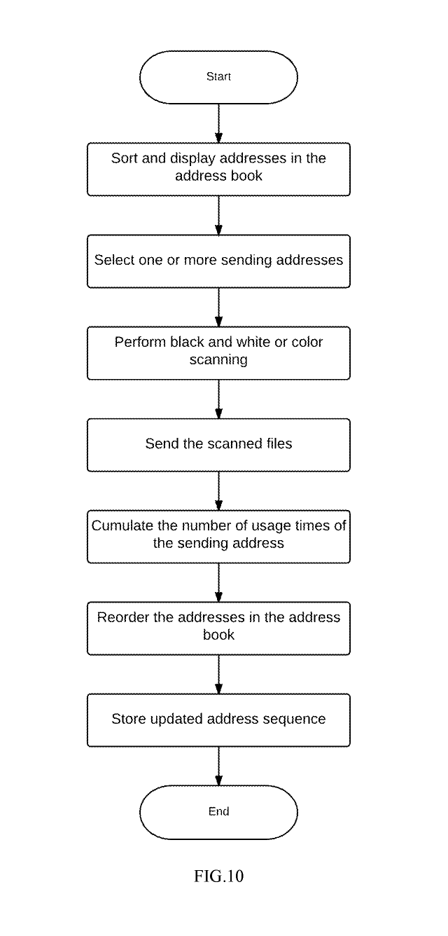

FIG. 10 is a flowchart illustrating a method of processing addresses;

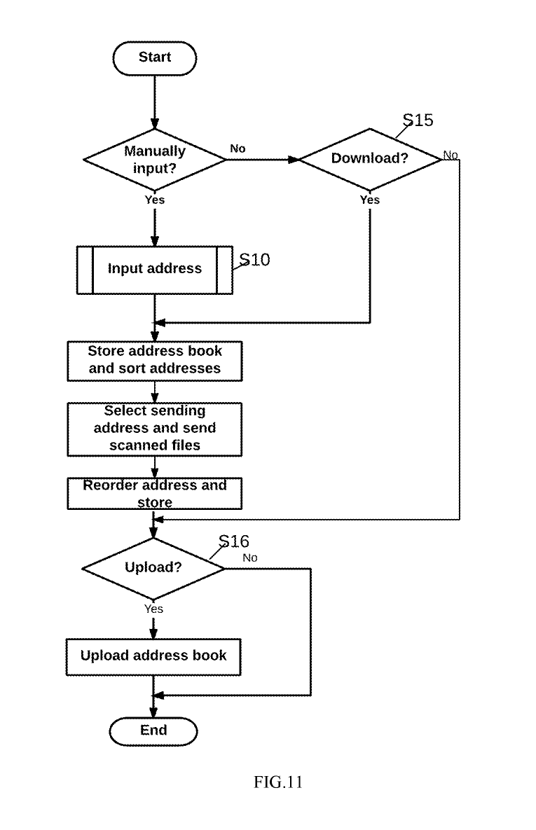

FIG. 11 is a flowchart illustrating a method of importing and exporting an address book;

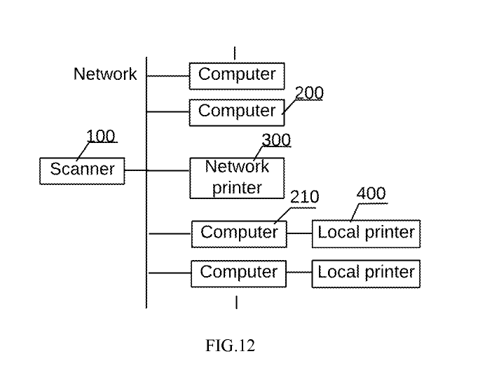

FIG. 12 is a schematic structural view of a system comprising a scanner, computers and printers according to an embodiment of the present invention;

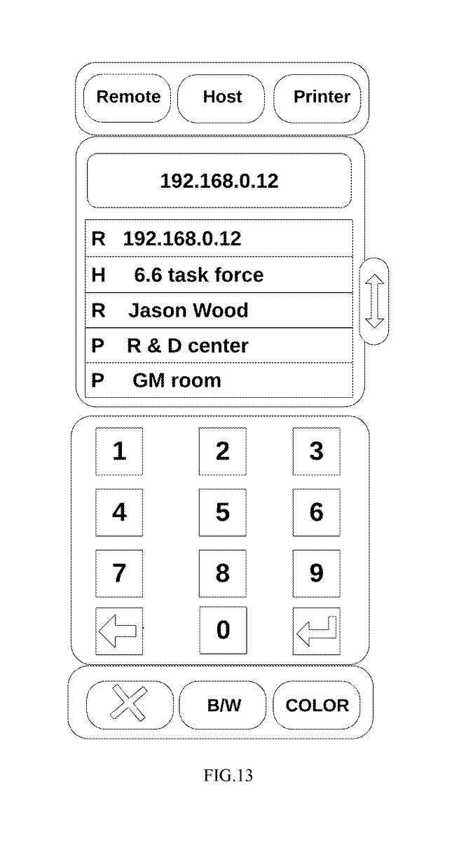

FIG. 13 is a schematic diagram illustrating an operation interface and a displaying interface of a scanner according to another embodiment of the present invention;

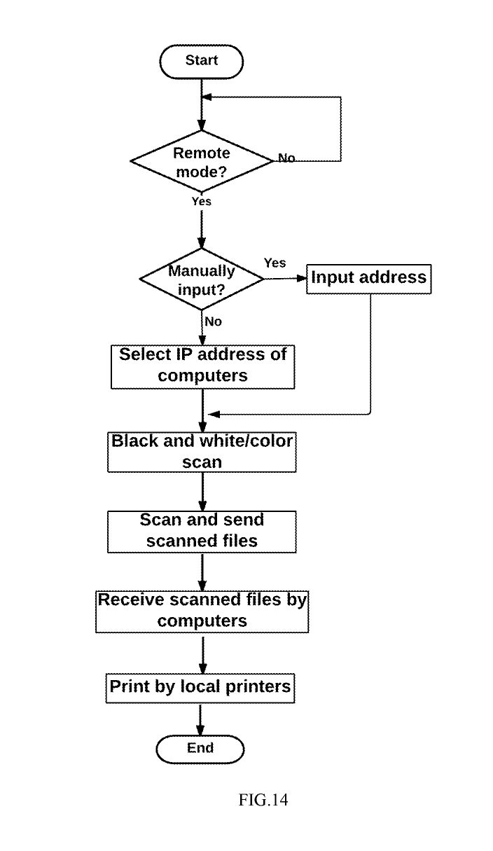

FIG. 14 is a flowchart illustrating a remote printing function of the scanner;

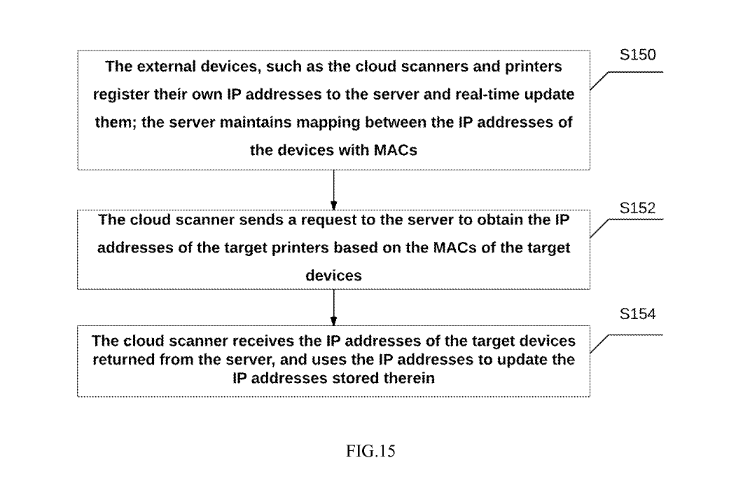

FIG. 15 is a flowchart illustrating a method of updating addresses;

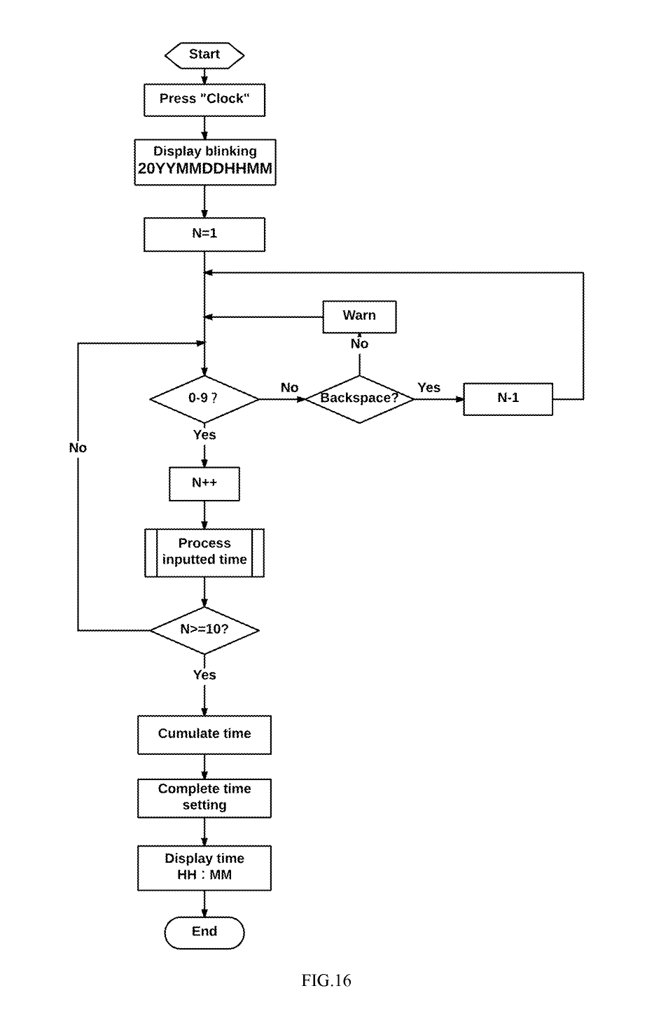

FIG. 16 is a flowchart illustrating a method of setting time on the scanner;

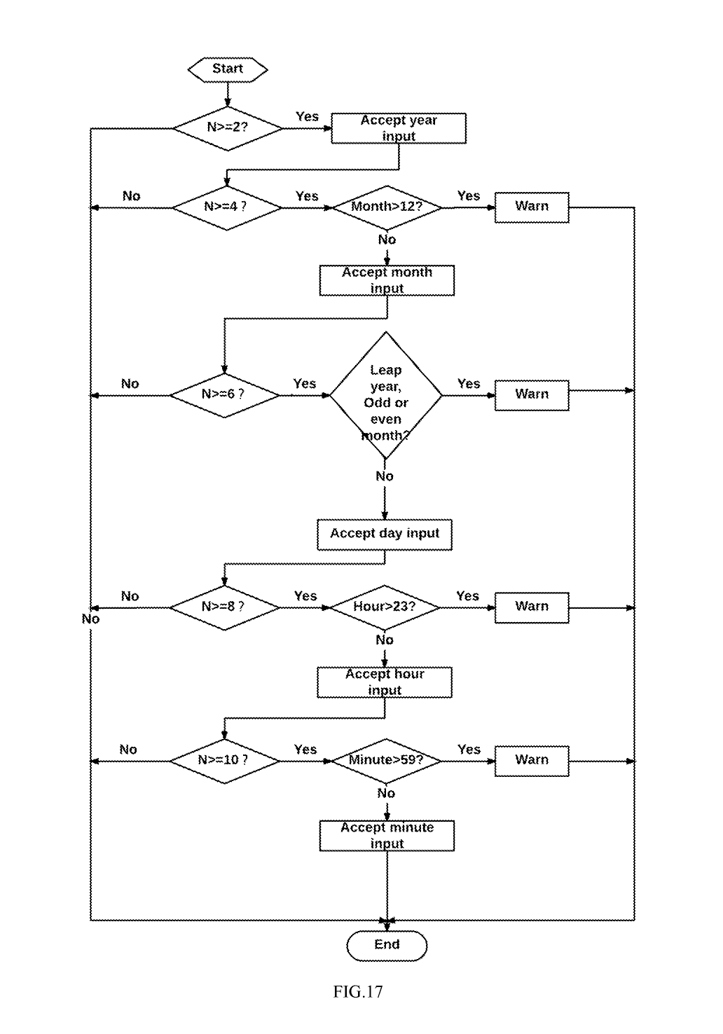

FIG. 17 is a flowchart illustrating a method of entering time; and

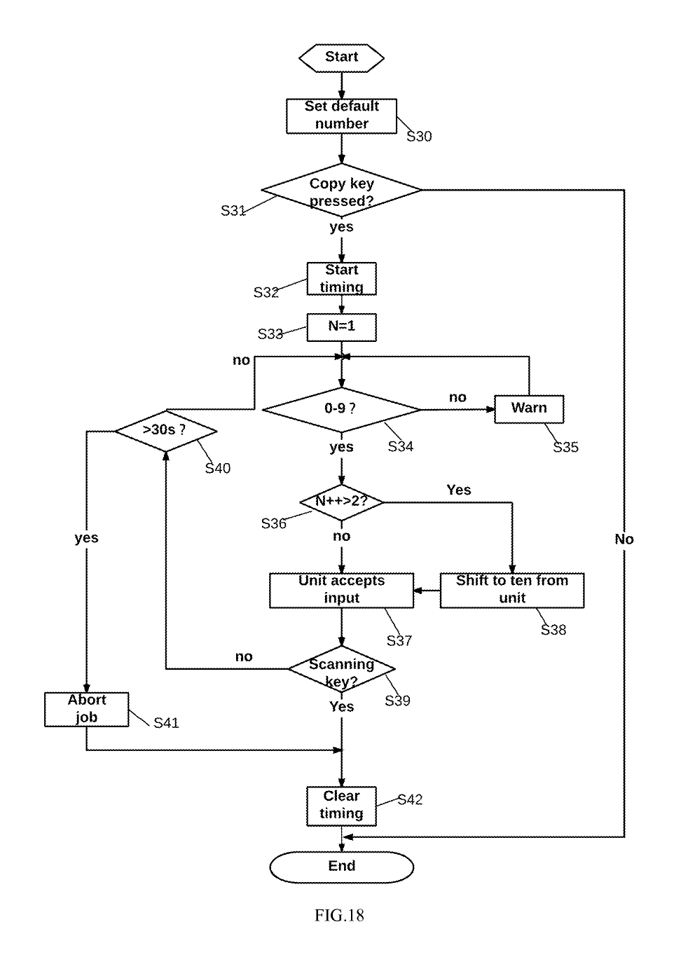

FIG. 18 is a flowchart illustrating a method of setting a printing copy number.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

A scanner having an address management function is proposed in the embodiments of the present invention. Such a scanner, e.g. a cloud scanner, is capable of being connected to a network, such as Internet, and communicating information with other devices via the network. The scanned files with any format can be sent to any network device or apparatus connected to the network, and then be edited, stored or printed. In addition, a scanner according to the embodiments of the present invention is configured to have many independent functions, and is capable of completing operations required by users independently, so as to get rid of relying on network computers. In other words, such a scanner is an independent network device, rather than a peripheral device of computers. A cloud scanner can be used by users independently, and provide safe information communication as well as complete and convenient functions, and can be closely associated with cloud functions of the network.

In cloud technology, each of the network devices and terminals is recognized with a unique Internet Protocol (IP) address. When scanned files are transmitted, the IP address of the recipient should be known. Currently, users need to remember and record complex and lengthy digital addresses, and input them into the scanner to transmit scanned files, which decreases the efficiency. Furthermore, it is likely to input an incorrect address, so that scanned files may be sent to a wrong recipient and lead to leakage of confidential information, or be sent to an invalid address or even cannot be sent. Accordingly, it is desired that a scanner has a complete address management function.

A scanner having an address management function according to an embodiment of the present invention will be described in detail hereinafter with reference to figures. It would be understood by those skilled in the art that the present invention is not limited to the following description.

FIG. 1 is a schematic structural view of a scanner according to an embodiment of the present invention. As shown in FIG. 1, a scanner 100 comprises a scanning module unit 101, a displaying unit 102, a network connection unit 103, a storing unit 104, a processor 105, an operation interface unit 106 and an address management unit 107. The processor 105 is connected to the scanning module unit 101, the displaying unit 102, the network connection unit 103, the storing unit 104, the operation interface unit 106 and the address management unit 107, and controls specific operations performed by them, for example controls the network connection unit 103 to transmit scanned files to one or more addresses of recipients.

The scanning module unit 101 includes common components of a scanner, such as an optical imaging module, and is used to scan documents to be scanned, such as texts, pictures, photographs, films or slides, so as to obtain images and then generate digital information. The scanning module unit 101 further includes a conversion unit (not shown) which processes the digital information obtained by scanning documents and convert it to document format which can be identified and printed by printers.

The address management unit 107 is configured to store an address book and sort addresses recorded in the address book with a certain rule. The address management unit 107 includes a sorting unit 107a which is configured to sort addresses recorded in the address book with a certain rule, for example based on the usage times of each address, and display the sorted address sequence on the displaying unit 102. Referring to FIG. 2, the displaying unit 102 includes a Light Emitting Diode (LED) display which includes a sending address displaying area 102c and an address sequence displaying area 102d.

The address management unit 107 identifies an address book imported from an external device, and stores it in the storing unit 104. The addresses recorded in the address book can be classified and marked, for example by computers, as hosting type addresses and printing type addresses. The hosting type addresses refer to the addresses of cloud servers which can receive scanned files, and the printing type addresses refer to the addresses of printers in the network. Referring to FIG. 2, the printing type addresses are marked as “P”, and the hosting type addresses are marked as “H”. However, the present invention is not limited thereto, for example, the addresses can be marked with icons.

The addresses recorded in the address book may be named aliases in advance. For example, as shown in FIG. 2, the IP address of 192.168.1.101 in the address book is named as “Beijing office”. After such an address book is imported, the scanner can identify the name including numerals and characters, and display it on the displaying unit 102. The aliases may include characters of different languages, such as Chinese, English, German, French, Japanese, Korean, Arabic and so on, as well as combination of them. In an embodiment, the sorting unit 107a sorts the addresses based on the initials thereof.

In an embodiment, if the address book has at least two addresses, the addresses may be grouped in advance and named group aliases. The group aliases may be identified by the address management unit 107 and be displayed on the displaying unit 102. Preferably, referring to FIG. 2, two or more related IP addresses in the address book may be assigned into a same group. For example, IP addresses corresponding to an investigation room and a technology room can be assigned to a group with an alias of “6.6 task force”. In such a case, the “6.6 task force” includes a plurality of IP addresses, and when it is selected, the plurality of IP addresses included therein will be deemed as the sending addresses and scanned files will be sent to the plurality of addresses simultaneously.

In another embodiment, one or more addresses can be selected with other ways, such as a check mode. With the check mode, one or more unnamed IP addresses, one or more aliases, one or more group aliases can be selected, and the scanned files can be sent to the corresponding IP addresses.

The address book may be imported into the scanner using a software after being named, labeled, classified and grouped by a computer. The information about aliases, groups and classification may be stored, identified and displayed by the scanner, and one or more addresses may be selected as sending addresses. In an embodiment, after scanned files have been sent to the one or more sending addresses, the processor 105 instructs the sorting unit 107a to add one to the number of usage times of the selected addresses, and sort all addresses again and store the sorted addresses. After that, the displaying unit 102 displays updated address sequence after re-sorting.

In an embodiment, the address management unit 107 may, under control of the processor 105, upload the address book stored in the storing unit 105 to an external memory space, e.g., a cloud server, so that the address book can be downloaded to computers and be imported to other scanners to share information. The external storage space may also be a memory disk or a mobile hard disk with a Universal Serial Bus (USB) port. The address book may be exported via the USB port or through a wireless sharing protocol. In another embodiment, the address management unit 107 may, under control of the processor 105, send the address book to other scanners directly to share information.

In an embodiment, the processor 105 controls the address management unit 107 to upload the address book to an external device for editing, for example classifying, marking, naming and grouping, the addresses. For example, the address book is exported to a computer or a Mobile Intelligent Device (MID) for editing, and the edited address book is imported back to the scanner or uploaded to a cloud server.

Herein, the term “addresses” or “IP addresses” means IP addresses of printers and cloud servers in the network. The scanner may be connected to the IP addresses, and send the scanned files to the IP addresses for printing or storing.

FIG. 2 is a schematic diagram illustrating an operation interface and a displaying interface of the scanner. As shown in FIG. 2, a “Print” key and a “Host” key are disposed on the scanner. After the scanner is activated, the address sequence displaying area 102d displays a mixed address sequence sorted based on usage times. After the “Print” key is pressed, the address sequence displaying area 102d displays an address sequence of sorted printing type addresses. Similarly, after the “Host” key is pressed, the address sequence displaying area 102d displays an address sequence of sorted hosting type addresses.

In an embodiment, in the address sequence displaying area 102d, five addresses are displayed in one page, and the first address in the sequence is selected automatically as the address of the recipient and displayed in a sending address displaying region 102c. A page turning key 110 is further included in the operation interface unit 106, and is configured to have a centrosymmetric structure. The page turning key 110 includes a plus setting portion 110a and a minus setting portion 110b. When a user presses the plus setting portion 110a or the minus setting portion 110b, pages will be turned up or down so that corresponding addresses will be turned up or down and the user can select a different address as the address of the recipient. With the plus setting portion 110a or the minus setting portion 110b, when the address to which the scanned files will be sent is ranked the first on the address sequence displaying area 102d, it will be selected as the address of the recipient automatically and displayed on the sending address displaying area 102c.

An operation panel 150 is further included in the operation interface unit 106. The operation panel 150 has numeric keys (0-9), a “Backspace” key and an “Enter” key etc. The operation panel 150 can be operated by users and a plurality of input settings can be made with these input keys.

In an embodiment, the operation interface unit 106 further includes a black and white scanning key 130a and a color scanning key 130b for performing black and white scanning and color scanning respectively, as well as a cancel key 103c for cancelling the current operation.

In an embodiment, the displaying unit 102 further comprises a time information displaying unit 102a. In such a case, the operation interface unit 106 further comprises a “Clock” key which will be described in detail later.

In an embodiment, the displaying unit 102 further comprises a printing copy number displaying unit 102b. In such a case, the operation interface unit 106 further comprises a printing copy number setting key 140 which will be described in detail later.

FIG. 3 is a flowchart illustrating operation of the scanner. Referring to FIG. 3 and also FIG. 2, it will be detected whether the “Host” key or the “Printer” key is pressed after the scanner is activated. If it is detected that the “Printer” key is pressed, at step S1, top 5 addresses of the printing type address sequence will be displayed on the address sequence displaying area 102d of the LED display. Next, timing is started, and it is determined in the processor 105 whether the black and white scanning key 130a or the color scanning key 130b (refereed collectively as the scanning key hereinafter) is pressed by the user. If so, black and white scanning or color scanning will be performed according to selection of the user, and then at step S4, a cumulating operation is performed for usage times of one or more selected sending addresses. Based on the result of cumulating, the sorting unit 107a sorts the printing type addresses again at step S5. If the user's selection on black and white scanning or color scanning is not received in a preset time period, e.g., 30s, from the timing is started, that is, triggering information of scanning key is not detected in a preset time period, this operation will be aborted.

Similarly, if it is detected that the “Host” key is pressed, at step S2, top 5 addresses of the hosting type address sequence will be displayed on the address sequence displaying area 102d of the LED display. Next, timing is started, and black and white scanning or color scanning will be performed according to selection of the user, and then at step S6, a cumulating operation is performed for usage times of one or more selected sending addresses. Based on the result of cumulating, the sorting unit 107a reorders the hosting type addresses at step S7. If triggering information of scanning key is not detected in a preset time period, this operation will be aborted.

After reordering of printing type addresses and hosting type addresses is completed, at step S8, all of the printing type addresses and hosting type addresses are reordered, and then the reordered address sequence is stored in the storing unit 104 at step S9.

FIG. 4 is a flowchart illustrating a hosting type function of the scanner. As shown in FIG. 4, after the “Host” key is pressed, top 5 addresses in the hosting type address sequence will be displayed on the scanner. It is determined whether the address is manually inputted, if so, the address input processing is performed at step S10, and timing is started after the processing ends. The subsequent steps are the same as corresponding steps shown in FIG. 3. That is, black and white scanning or color scanning will be performed according to selection of the user, and then at step S6, a cumulating operation is performed for usage times of one or more selected sending addresses. Based on the result of cumulating, the sorting unit 107a reorders the hosting type addresses again at step S7. If triggering information of scanning key is not detected in a preset time period, this operation will be aborted.

FIG. 5 is a flowchart illustrating a method of displaying top 5 hosting type addresses. As shown in FIG. 5, after the “Host” key is pressed, the address sequence stored in the storing unit 104 will be read, and it is determined whether the number of the addresses displayed on the LED display exceeds five. If not, reading and displaying is continued; otherwise, it is determined whether there is triggering information of the plus setting portion 110a or the minus setting portion 110b of the page turning key 110, that is, whether the plus setting portion 110a or the minus setting portion 110b is pressed. If none of the setting portions 110a and 110b is pressed, the first address displayed on the address sequence displaying area 102d will be stored as the sending address automatically and displayed on the sending address displaying area 102c.

In contrast, if it is detected that either of the setting portions 110a and 110b is pressed, page up operation or page down operation will be performed, and corresponding address will be stored as the sending address and displayed on the sending address displaying area 102c.

As an example, there are 32 sorted addresses in the address book. In the flowchart shown in FIG. 5, variable k means the serial number of addresses in the address book, and i+k means the five addresses updated and displayed on the LED display.

FIG. 6 is a flowchart illustrating a method of cumulating usage times of the hosting type addresses. As shown in FIG. 6 and also referring to FIG. 5, it is determined whether the name of the selected address in the completed scanning sending operation is an alias or a group alias or void. Here, the alias refers to a unique name of an IP address, for example “Beijing office” shown in FIG. 2, the group alias refers to a unique name of a group having a plurality of IP addresses, for example “6.6 task force” shown in FIG. 2.

If it is determined that the name is an alias, the number of usage times of the IP address corresponding to the alias will be added one. If it is determined that the name is a group alias, the number of usage times of the group corresponding to the group alias will be added one and the number of usage times of each IP address in the group will be added one also. And if it is determined that the name is void, that is, the name is neither alias nor group alias, the number of usage times of the digital type IP address will be added one. Based on the result of cumulating, the sequence of hosting type addresses is adjusted, and the sequence of all hosting type addresses and printing type addresses is adjusted. New sequence will be stored.

FIG. 7 is a flowchart illustrating a printing type function of the scanner. As shown in FIG. 7, after the “Printer” key is pressed, top 5 addresses in the printing type address sequence will be displayed on the scanner. Next, it is determined whether the address is manually inputted, if so, the address input processing is performed at step S10, and the printing copy number is set at step S14 based on the requirements of the recipient after the processing ends, and then timing is started.

The subsequent steps are the same as the corresponding steps shown in FIG. 3. That is, it is determined in the processor 105 whether the black and white scanning key 130a or the color scanning key 130b is pressed by the user. If so, black and white scanning or color scanning will be performed according to selection of the user, and then at step S4, a cumulating operation is performed for usage times of one or more selected sending addresses. Based on the result of cumulating, the sorting unit 107a reorders the printing type addresses at step S5. If the user's selection on black and white scanning or color scanning is not received in a preset time period, e.g., 30 s, from the timing is started, that is, triggering information of scanning key is not detected in a preset time period, this operation will be aborted.

The displaying of top 5 addresses, the address input processing and the cumulating processing for the number of usage times of the printing type function is similar as those of the hosting type function, detailed description thereof will be omitted in order to avoid redundancy.

FIG. 8 is a flowchart illustrating a method of inputting addresses. As shown in FIG. 8, N represents the number of digits accepted by the scanner. Because an IP address includes 12 digits, the number of inputted digits reaching 12 means that the inputting is complete. That is, if it is judged that N>=12, it can be determined that the address inputting is completed and the inputting procedure is ended. Since an IP address includes only digits, an input which is not a number between 0-9 means the input is not correct and will not be accepted. In such a case, it is judged whether the backspace key is pressed, if so, an accepted number will be deleted and the counter will be subtracted 1 (N−1). If the input is neither number nor the backspace key, a warning will be issued to prompt the user of an input error.

FIG. 9 is a flowchart illustrating a method of inputting network addresses. As shown in FIG. 9, when a network address is needed to be entered, the user can trigger the numeric keys (0-9) on the operation panel 105 to enter the network address. When the user triggers the numeric keys and the time period maintaining the triggering is greater than or equal to a preset time period threshold, the corresponding numbers and point symbols will be entered and displayed on the LED display 102. When the user triggers the numeric keys and the time period maintaining the triggering is less than the preset time period threshold, the corresponding numbers will be entered and displayed on the LED display 102. After a network addresses is entered, the network address is processed by the address management unit 107 and then stored in the storing unit 104. The time period threshold can be preset and adjusted according to the user's operating habits.

When an operation mistake is found, the user may delete the entered numbers or the entered numbers and point symbols using the cancel key 130c on the operation panel 105.

With the method of entering a network address according to an embodiment of the present invention, additional point symbol keys are not required, thus panel and space of the scanner is saved, the number of steps of operations is reduced, and speed and efficiency of entering is improved.

FIG. 10 is a flowchart illustrating a method of processing addresses. As shown in FIG. 10, after a plurality of addresses in the address book is sorted to an address sequence, the address sequence is displayed on the LED display as shown in FIG. 2. As described before, the sorting may be performed based on usage times of each address. The addresses in the address book may be classified to hosting type addresses and printing type addresses which may be sorted separately. At least two addresses in the address book may be grouped in advance and each group may be named as a group alias. Then the user selects one or more addresses as sending addresses, and performs black and white or color scanning, and then sends the scanned files to the selected sending addresses. The address management unit 107 cumulates the number of usage times of the sending addresses and reorders the addresses in the address book, and the reordered addresses are stored then.

FIG. 11 is a flowchart illustrating a method of importing and exporting an address book. As shown in FIG. 11, it is judged whether an address will be entered manually, if so, the address entering processing will be performed at step S10, and then the address book is stored and sorted; otherwise, it is further judged whether an address book will be downloaded from a computer at step S15, if so, an address book is downloaded from the computer and stored in the storing unit 104. After the address book is stored, a sending address is selected, scanning is performed and scanned files are sent to the sending address. After that, addresses in the address book are reordered, and then it is judged whether it is needed to upload the address book at step S16. If the judgment result is “no” at step S15, step S16 will be performed immediately.

At step S16, if it is determined that it is needed to upload the address book, the address book will be uploaded to a computer or a cloud server; otherwise this procedure is ended. As described before, the address book uploaded to a computer or a cloud server may be stored, reedited or shared.

It could be seen from the above-mentioned embodiments that the scanner according to embodiments of the present invention has a complete address book management function. For example, an address book can be imported into the scanner, and the address book can be exported to an external storage device or an external management device for storing, reediting and sharing. The addresses can be sorted based on a certain rule, and the sending address can be selected quickly and easily, without performing a troublesome separate digital address inputting, so as to reduce the number of keys or steps and provide quick, accurate, convenient document scanning and transmission. Furthermore, the scanned files can be sent to a plurality of addresses stimulatingly based on quick selection for the address book, which can improve the usage efficiency and convenience of the scanner greatly.

In some instances, not all printers are connected to the network so that they can directly receive the scanned files and print them. In such a case, an embodiment is provided in which the scanned files are sent to a printer which is not connected to the network directly.

FIG. 12 is a schematic structural view of a system comprising a scanner, computers and printers according to an embodiment of the present invention. As shown in FIG. 12, a scanner 100, computers 200, 210, network printers 300 and local printers 400 constitute a remote printing system. The local printers 400 are connected to the computers 210 via USB ports so as to receive and transmit data. The computers 210 connected to the network in a wire or wireless way can transfer date with the scanner 100. After being received by the computers 210, scanned files sent from the scanner 100 can be printed by the local printers 400 connected to the computers 210 directly, without the computers 210 sending an instruction to the local printers 400. That is, the scanned files obtained from the scanner 100 can be printed by the local printers 400 which have no network connection with the scanner 100.

FIG. 13 is a schematic diagram illustrating an operation interface and a displaying interface of a scanner according to another embodiment of the present invention. As shown in FIG. 13, the operation interface unit 106 further includes a remote printing setting key (“Remote”) used to set remote printing mode of the scanner.

FIG. 14 is a flowchart illustrating a remote printing function of the scanner. As shown in FIG. 14, firstly it is determined whether the user has set the remote printing mode. If it is determined that the user triggered or pressed “Remote” key, the remote printing mode is activated. Next, it is determined whether the user wants to set the IP addresses of the computers 210 by entering the address manually, if so, address entering processing is performed; if not, the IP addresses of the computers 210 are selected from the stored address book.

With the system and method described above, the scanned files can be sent to not only network printers, but also computers so that local printers which are connected to the computers but have no network connection with the scanner can print the scanned files directly. Thus, traditional printers can be used to print scanned files obtained from the scanner, without a need to purchasing additional network printers, which extends the usage of scanners and saves operation cost for the users.

In the embodiments described above, IP addresses are used in communication between the scanner and the external devices. However, in some instances, the IP addresses of the scanner, remote printers or other external devices are changed frequently. In order to ensure that recipients can be accessed accurately using the IP addresses, a method of updating the IP addresses is proposed.

FIG. 15 is a flowchart illustrating a method of updating addresses. As shown in FIG. 15, at step S150, the external devices, such as the cloud scanners and printers register their own IP addresses to the server and real-time update them. The server maintains mapping between the IP addresses of the devices with Media Access Controls (MACs).

At step S152, the cloud scanner sends a request to the server to obtain the IP addresses of the target printers based on the MACs of the target devices.

At step S154, the cloud scanner receives the IP addresses of the target devices returned from the server, and uses the IP addresses to update the IP addresses stored therein.

In an embodiment of the present invention, the scanner 100 further includes an address updating module which is used to communicate with the server, automatically update its own IP address to the server and update the IP addresses in the address book stored in the storing unit.

In an embodiment of the present invention, the scanner 100 also supports a time setting function. The user can set time manually with the operation panel 150, or obtain a real-time time information from a server connected in the network via the network connection unit 103. The time information is stored in the storing unit 104.

The time information includes date and standard time which are represented with 12 codes. Specifically, year is represented with 4 codes, each of month, day, hour and minute is represented with 2 codes. For example 2010-08-30-12-02 means 12:02 on August 30, 2010.

In an embodiment of the present invention, the time information is included in the scanned files, and can be printed optionally by the recipient.

In an embodiment of the present invention, standard time information is displayed on the time information displaying area 102a of the LED display, with the format of HH: MM, such as “10:30” shown in FIG. 2.

In this case, the scanner 100 may further include a time setting unit for setting time information. The time setting unit comprises a time setting module used to set time information based on manual inputting via the operation panel 150, and a time information writing unit for writing the time information to the scanned files.

FIG. 16 is a flowchart illustrating a method of setting time on the scanner. As shown in FIG. 16, when the “Clock” key is triggered, the sending address displaying area 102c is activated as a time editing displaying area which displays a flickering time setting format, i.e. twelve-code format, e.g., “20YYMMDDHHMM”. The user may set the current time by tapping the operation panel 150. After the user enters a definite time, the time setting format in the time editing displaying area will not blink. In the case of entering a wrong time, the user can correct the time using the backspace key, until the correct date is entered. The set time information is stored in the storing unit 104 and can be accessed by the processor 105. The processor 105 reads the time information, and processes, e.g., cumulates, them with a certain rule, for example for hour, minute, second, month and year. The processor 105 stores the processed time information in the storing unit 104. When required, the processor 105 reads the standard time information from the storing unit 104 and displays it on the time information displaying area 102a shown in FIG. 2, for example with the format of HH: MM.

In FIG. 16, N represents the number of user input times. When what the user inputs is among 0-9 numeric keys, then N=N+1; when it is the backspace key, then N=N−1;

when it is neither 0-9 numeric keys nor the backspace key, then the user will be prompted that the current input is incorrect through a warning sound, since only 0-9 numeric keys and the backspace key are accepted during time setting.

As shown in FIG. 17, if the number of entering times for 0-9 numeric keys is greater than or equal to 2, the time editing displaying area in FIG. 2 will accept the setting for year, otherwise the procedure ends and accepts the user's re-entering. If the number of entering times for 0-9 numeric keys is greater than or equal to 4, it is further judged whether the month entered by the user is greater than 12, if not, the month entered by the user will be accepted, otherwise the user will be prompted that the entered month is greater than 12 through a warning sound, meanwhile the processor 105 processes the time format and the user's re-entering will be accepted. If the number of entering times for 0-9 numeric keys is greater than or equal to 6, it is judged whether the year and month information is correct, if so, the input for day will be accepted, otherwise the user will be prompted that the entered information is not correct through a warning sound, meanwhile the processor 105 processes the time format and the user's re-entering will be accepted. If the number of entering times for 0-9 numeric keys is greater than or equal to 8, it is further judged whether the hour entered by the user is greater than 23, if not, the hour entered by the user will be accepted, otherwise the user will be prompted that the entered hour is not correct through a warning sound, meanwhile the processor 105 processes the time format and the user's re-entering will be accepted. If the number of entering times for 0-9 numeric keys is greater than or equal to 10, it is further judged whether the minute entered by the user is greater than 59, if not, the minute entered by the user will be accepted, otherwise the user will be prompted that the entered minute is not correct through a warning sound, meanwhile the processor 105 processes the time format and the user's re-entering will be accepted. If N is greater than 10, the current time setting is completed and the time information will be processed, e.g., cumulated, and the set time information will be displayed to the user via the time information displaying area 102a, with the format of HH: MM.

In an embodiment of the present invention, the scanner also supports a printing copy number setting function, that is, the number of copies to be printed may be preset according to requirements of the recipient. The user may enter the number of copies to be printed through the operation panel 150, and the printing copy number is set based on the entered number. The processor 105 controls a copy number displaying module to display the number on the printing copy number displaying area 102b.

The processor 105 determines whether to activate printing copy setting status according to triggering status of a functional key 140 shown in FIG. 2. The functional key 140 located on the LED display 102 is adjacent to the printing copy number displaying area 102b.

In an embodiment of the present invention, the printing copy number displaying area 102b is configured to accept a two-digit number of copies, i.e., the maximum number of copies which can be set and displayed is 99. Thus, based on the information of entered numeric keys (0-9), the processor 105 sets the last two numerals of the entered information as the set number of printing copies, and displays it on the printing copy number displaying area 102b, which will be described in more detail later. So, the printing copy number can be set through a simple entering operation, without an additional confirmation action. However, the present invention is not limited thereto, for example, the maximum number of copies can be greater than 99.

If the user finds that the set printing copy number does not accord to the requirements of the recipient, or if there is a mistake in operation, the current operation can be cancelled by triggering the cancel key 130c shown in FIG. 2. The processor 105 detects the triggering status of the cancel key 130c and determines whether to cancel the set printing copy number based on the detected result. If the set printing copy number is canceled, the printing copy number may be reset as 1, and setting the printing copy number and confirming printing operation may be performed again.

In an embodiment, the scanner further has an automatic resetting function. A built-in timing module (not shown) is included in the processor 105. If the scanning key 130a or 130b is not triggered in a preset time period, e.g. 30 s, after the printing copy number is capable of being set, or if no information on the printing copy number is received via the operation panel 150 in a preset time period, e.g. 30 s, after the functional key 140 is pressed, the processor 105 closes the setting status of the printing copy number, and 1 will be set as the printing copy number and will be displayed on the printing copy number displaying area 102b.

FIG. 18 is a flowchart illustrating a method of setting printing copy number. As shown in FIG. 18, at step S30, the scanner is activated and the default printing copy number of 1 is displayed. Next, at step S31, the processor 105 detects the triggering status of the printing copy number setting key 140. If no triggering or pressing of the printing copy number setting key 140 is detected, procedure ends. In contrast, if triggering or pressing of the printing copy number setting key 140 is detected, the timer is started and begins to timing at step S32, and the default printing copy number of 1 is displayed on the printing copy number displaying area 102b while blinking

Next, at step S34, the processor 105 determines whether the entered number is among (0-9), if not, a warning message is sent at step S35, and the processor 105 continues to determine whether the entered number is among (0-9). The warning message is sent via a sound signal or an optical signal. In an embodiment, the processor 105 is connected to a sound generator such as a buzzer or a light generator such as a red LED so that a sound signal or an optical signal can be sent to the user.

If the entered number is among (0-9) at step S34, it is further determined whether the entered times number N is greater than 2 at step S36, if not, the unit accepts entering at step S37, otherwise in the case of the maximum number which can be set and displayed by the scanner being 99, the unit is shifted to the ten at step S38 and continues to accept entering for the unit at step S37, so as to complete the setting of the printing copy number.

Next, the processor 105 determines whether the scanning key 130a or 130b is triggered at step S39, if it is detected that the scanning key 130a or 130b is triggered or pressed, at step S42, the timing is cleared and the scanning and sending operations are performed. In contrast, if it is not detected that the scanning key 130a or 130b is triggered or pressed, the processor 105 controls sending of a warning message and starts timing. If it is detected that the scanning key 130a or 130b is triggered or pressed in a preset time period, e.g. 30 s, at step S40, step S34 will be implemented, otherwise the setting operation will be aborted at step S41, and timing is cleared and the procedure is ended.

It could be seen in some embodiments of the present invention, time information can be set in the scanner and be sent to the recipient by being included in the scanned files. The sending addresses can be selected quickly. The printing copy number can be set conveniently according to the requirements of the recipient, and a plurality of copies can be printed when the recipient receives the scanned files. The scanner have many functions such as time setting, address setting and printing copy number setting, thus provides excellent experience for users and improves usage efficiency. Furthermore, the scanner can be made small and can be connected to the network wirelessly, which is convenient for telecommuting.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A scanner, comprising:
a scanning module unit configured to perform scanning operations;
a storing unit configured to store addresses of recipients;
an address management unit configured to edit and sort the addresses stored in the storing unit;
an operation interface unit configured to receive selection of one or more addresses of recipients based on results of the editing and sorting of the address management unit;
a network connection unit connected to a network; and
a processor connected to the scanning module unit, the address management unit, the operation interface unit and the network connection unit, and configured to control operations performed by the scanning module and transmission of scanned files to the one or more addresses of recipients by the network connection unit.

2. The scanner according to claim 1, further comprising a displaying unit, wherein the displaying unit comprises an address sequence displaying area for displaying the result of the editing and sorting of the address management unit, and the result is selectable via the operation interface unit.

3. The scanner according to claim 2, wherein the operation interface unit comprises a page turning key which includes a plus setting portion and a minus setting portion used for selection of sequence of the addresses displayed on the displaying unit.

4. The scanner according to claim 2, wherein the operation interface unit comprises a printing key, when the printing key is pressed, the displaying unit displays an address sequence of sorted printing type addresses, the processor transits the scanned files to the first address displayed on the address sequence displaying area through the network connection unit for printing.

5. The scanner according to claim 2, wherein the operation interface unit further comprises a hosting key, when the hosting key is pressed, the displaying unit displays an address sequence of sorted hosting type addresses, the processor transits the scanned files to the first address displayed on the address sequence displaying area through the network connection unit for hosting.

6. The scanner according to claim 2, wherein the operation interface unit further comprises a remote printing key, when the remote printing key is pressed, the processor transits the scanned files to the first address displayed on the address sequence displaying area through the network connection unit, the first address is an IP address of a computer.

7. The scanner according to claim 2, wherein the operation interface unit further comprises a time key, when the time key is pressed, a time editing displaying area showing a time setting format is displayed in the displaying unit, the time setting is performed by a user manually through the operation interface unit, and the set time information is stored in the storing unit.

8. The scanner according to claim 7, wherein the network connection unit is connected to a network server to obtain real-time time information.

9. The scanner according to claim 7, wherein the time information is written into the scanned files through the operation interface unit, and is optionally printed.

10. The scanner according to claim 2, wherein the operation interface unit further comprises a printing copy number setting unit, the displaying unit is further configured to display the printing copy number.

11. The scanner according to claim 10, wherein the operation interface unit further comprises a cancel key, the processor determines whether to reset the printing copy number based on an operation status of the cancel key.

12. The scanner according to claim 11, wherein the operation interface unit further comprises a printing copy number activation key, the processor determines whether to activate a setting status of the printing copy number according to an operating status of the printing copy number activation key.

13. The scanner according to claim 12, wherein the processor resets the printing copy number if no information is inputted via the operation interface unit in a preset time period under the setting status of the printing copy number or no scanning operation confirmation information is received in a preset time period after the printing copy number is set.

14. The scanner according to claim 1, wherein the addresses stored in the storing unit have aliases, and/or
at least two addresses are grouped and named a group alias.

15. The scanner according to claim 14, wherein the sorting of the address management unit is based on usage frequency of each address or each group of addresses, and/or initial of alias of each address or group alias of each group of addresses.

16. The scanner according to claim 1, wherein the operation interface unit comprises input keys used for inputting of the addresses of the recipients, and the inputted addresses are stored in the storing unit.

17. The scanner according to claim 16, wherein the input keys do not include point symbols, if triggering time period of inputting of the input keys is greater than or equal to a threshold, numerals and point symbols corresponding to the input keys are displayed, and if the triggering time period of inputting of the input keys is less than the threshold, numerals corresponding to the input keys are displayed.

18. The scanner according to claim 1, wherein the address management unit is further configured to identify an address book inputted from outside through the network connection unit or a USB port, and store the address book in the storing unit; and/or
the address management unit is further configured to export the addresses stored in the storing unit to an external address book through the network connection unit or the USB port.

19. The scanner according to claim 1, wherein the operation interface unit comprises a black and white scanning key, and/or a color scanning key, and/or a cancel key.

20. The scanner according to claim 1, further comprising an address updating module which is configured to communicate with a server, automatically update its own address to the server and update the addresses stored in the storing unit.
